(19) United States
(12) Patent Application Publication
(10) Pub. No.: US 2004/0245790 A1
(43) Pub. Date: Dec. 9, 2004

(54) Janitor tweezers

(76) Inventor: William Thomas, Oakland, CA (US)

Correspondence Address: William Thomas, Station D, PO Box 70303, Oakland, CA, 94612, US

(21) Appl. No.: 10/452,958

(22) Filed: Jun. 4, 2003

(51) Int. Cl. B25J 1/02

(52) U.S. Cl. 294/16

(57) ABSTRACT

The Cleaning Industry has long needed a tool like the Janitor Tweezers to pick-up and remove unsanitary items from Toilet Bowls, Urinals, Floors, etc. The design allow the user to quickly close and store the unit, taking up little or no space. It can be carried in pockets, on Vacuums Cleaners, Cleaning carts, Dust Mop Handles for the many daily Cleaning Duties performed. It eliminate the individual from putting their hands directly on unsanitary items. Helps to reduce stress and strain of the body by reducing total stooping, bending to pick-up items.

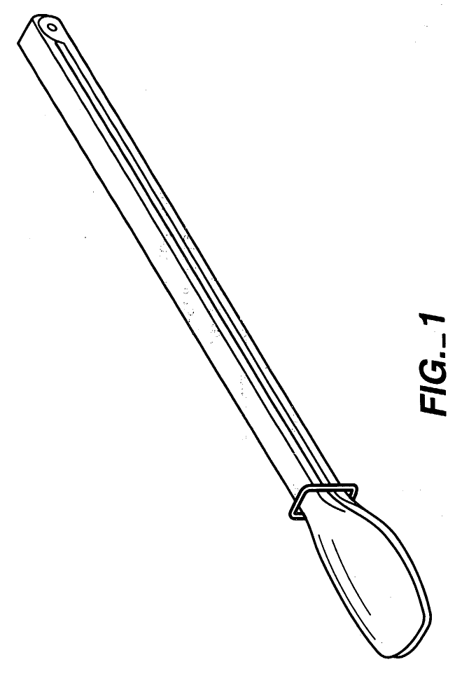

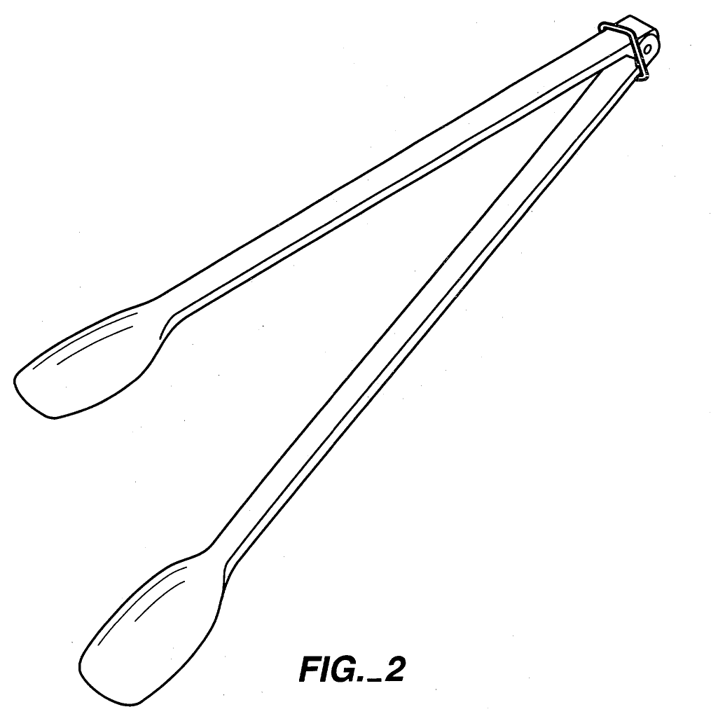

Part of the job of a Professional Custodial Cleaning and Maintenance person is to remove unsanitary debris and place them in the trash. Because there are many contagious diseases that can be transmitted from one person to another. It make good sense to protect one self. There are many places where unsanitary items are removed each day.

Hospital Cleaning

1. Needles that are accidentally left by medical staff who are extremely busy.

2. Used bandages that contain pus, and other bodily fluids.

3. Patients towels, face cloths, etc., from a contaminated room.

4. Patients restroom, from catheter bags to used tissue paper that may be contaminated.

5. Patients trash containers are a dangerous area for contacting disease.

6. Urinals, people put all type of debris in urinals, from chewing gum to paper, etc.

7. Toilet Bowls, ask any School Custodian, they will tell you that there is not a day passes that something has to be taken out of the toilet bowl, urinal, or off the floor, etc.

8. Plugged toilet bowls, many times paper and other debris have to be removed from toilet bowls before you can use a Toilet Plunger to unplug them.

9. Feminine Hygiene Products, this is a daily job to remove from Wall Containers.

Classroom Cleaning

1. To be a Professional Custodian mean stooping, bending, twisting, reaching, pulling, pushing to mention a few body motions.

2. Classroom Cleaning always start with picking up pencils, pens, erasers, crayons, etc., that are always left on the floor or under desks. One half of all pencils, pens, erasers, crayons are swept up in the Custodians Dust Pan. Time does not permit the Custodian to stoop or bend down and pick up each item. The Janitor Tweezers will allow the Custodian time to perform this duty.

3. Students get sick, paper towels are placed over it, this has to be picked up. A job for the Janitor Tweezers.

4. Paper Wads and other items thrown in between wall and furniture, etc.

5. Because of most school budgets, trash liners are not changed daily. Face tissue that students and staff use are discarded. Some times items stick to trash liners, they have to be removed by hand. Janitor Tweezers will solve this problem.

6. When the Custodian police the playground, pieces of paper, cans, bottles, broken glass can quickly be removed. Quite often bottles and cans are left half full of liquid. Liquid can easily be dumped without touching the container.

7. Office Cleaning, daily there is paper on the floor, especially under desks where waste baskets are usually kept. Office workers throw paper in waste baskets, many times it end up on the floor. Many times the Custodian will have to get down on their hands and knees to get paper wads. Imagine doing this 20-30 times doing the Cleaning Shift. The Janitor Tweezers will solve this problem.

Think about the ten's of thousands of waste baskets emptied each day in your city from Office Buildings, Schools, Hospitals, etc. This tool is well past due.

Method Presently Used to Remove Unsatitary Debris to Trash

In the Cleaning Maintenance Industry you hear, “Glove-Up,” this mean to put on Rubber gloves and pick-up unsanitary debris, this duty is not popular with Professional Custodians, They dislike putting their hands in Toilet Bowls, Urinals to remove toilet paper rolls that some students have thrown in it. If rubber gloves are not disinfected after each and every use they become contaminated and will spread germs which is dangerous to the employee's health. The Janitor Tweezers will solve this problem. The Janitor Tweezers are made of Stainless Steel and are spring loaded at the top, allowing it to spring open and close with no effort to the user. It can easily be cleaned and disinfected. This is a Cleaning Tool that every Professional Custodian will use daily. The wire sleeve allows user to quickly close and store. It can be carried in Professional Custodians Pocket, Cleaning Carts, Hooked on Vacuum Cleaners, etc. The Janitor Tweezers length start at 12″ up to 26″. The Janitor Tweezers can be used by persons who may have problems stooping over to retrieve various items from floors, etc.

1. I claim that the Janitor Tweezers will eliminate Individuals, Professional Custodians, Cleaners from using their hands to remove unsanitary items from floors, toilet stools, urinals, waste baskets, etc. It will assist in providing Cleaning Safety to individuals. It will assist individuals who may have a problem bending, twisting, stooping, etc., to retrieve items from floors, etc.

2. I claim that there is no other Cleaning Tool Product presently on the market of this size, shape, price to produce results as this Janitor Tweezers.
